(19) United States
(12) Patent Application Publication
(10) Pub. No.: US 2002/0152095 A1
(43) Pub. Date: Oct. 17, 2002

(54) Creative license, a seamless process to search for, synchronize, and license music in visual media

(76) Inventor: Herbert Jordon, Beverly Hills, CA (US)

Correspondence Address: Herbert Jordon, 9751 Gregory Way, Beverly Hills, CA, 90212, US

(21) Appl. No.: 10/117,745

(22) Filed: Apr. 5, 2002

Related U.S. Application Data
(60) Provisional application No. 60/282,255, filed on Apr. 6, 2001.

(51) Int. Cl. G06F 17/60; G06F 7/00; G06F 17/30; G06F 17/00

(52) U.S. Cl. 705/1; 707/3; 707/104.1

(57) ABSTRACT

A seamless process to search for, synchronize with a visual image, and license music in Visual media, with the steps of: installing music catalogs digitally in an audio database, through which users access, synchronize and license the music.

### CROSS REFERENCE TO RELATED APPLICATIONS

This is a continuation of Provisional Application Serial No. 60/282,255, filed on Apr. 6, 2002, and is also based on provisional application serial No. 60/282,255, filed on Apr. 6, 2002.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of the use of music in film and television and more specifically to a seamless process to search for, synchronize, and license music for use in Visual media.

Search engines have existed for several years. Online search, licensing and synchronization are novel.

No Patents appear to combine the search for, synchronization of and licensing or music online.

No patented technology allows users to search for music, stream and download it into personal computers and editing devices and license it through a single mechanism.

### BRIEF SUMMARY OF THE INVENTION

The primary object of the invention is to reduce the distance between a film synchronization idea and its realization to virtual zero.

Another object of the invention is to expand the musical choices for those who employ music in Visual media.

Another object of the invention is to make the search for, synchronization of, and licensing of music a seamless unitary process.

A further object of the invention is to create an interface for different elements of the Film, Television, Advertising, and Music industries.

Yet another object of the invention is to facilitate a flow of digital information and music in both directions.

Still yet another object of the invention is to promote the increased use of music in Visual media.

Another object of the invention is to create a system for tracking and managing uses of copyrighted musical content used in the Visual media.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a seamless online process to search for, synchronize, and license music in Visual media, comprising the steps of creating a digital audio database of songs capable of being accessed, synchronized into visual media and licensed online.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a View of the search options of the invention

FIG. 3 is a view of the search schematic of the invention.

FIG. 4 is a view of the search results produced by the invention.

FIG. 5 is a view of the saved search function.

FIG. 6 is a view of the segment selection function of the invention.

FIG. 7 is a view of the search results with video image

FIG. 8 is a view of the licensing function of the invention.

FIG. 9 is a view of the certification-protected log in

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Creative License Patent Description

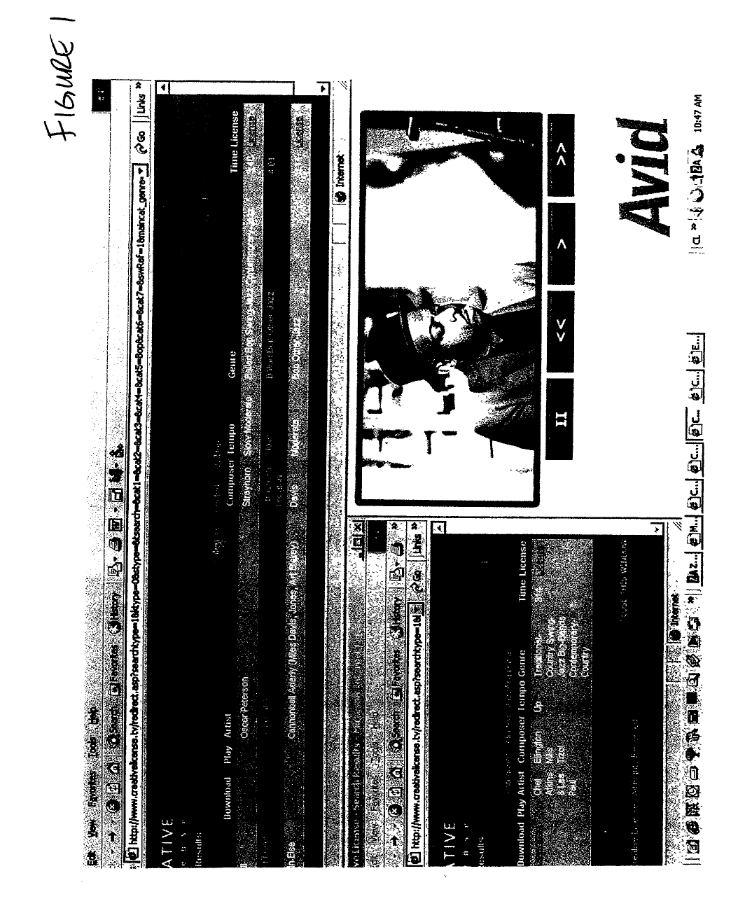

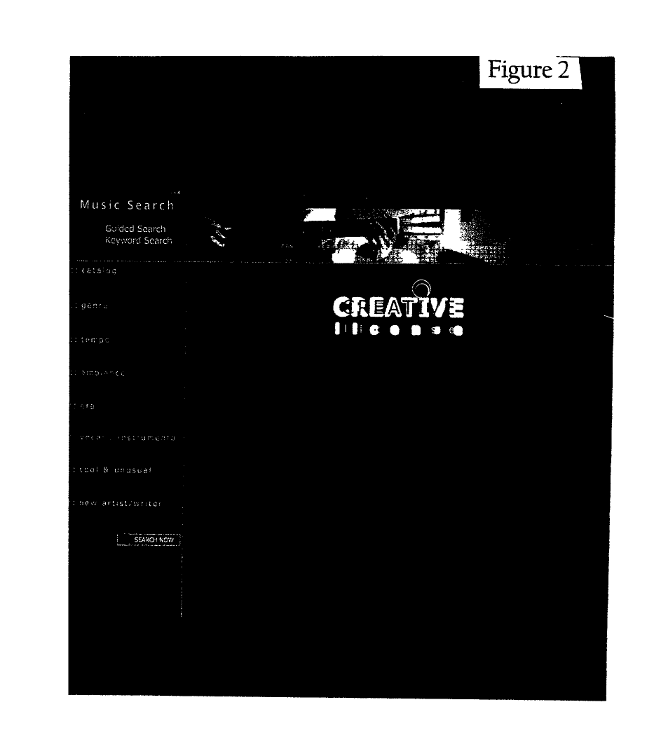

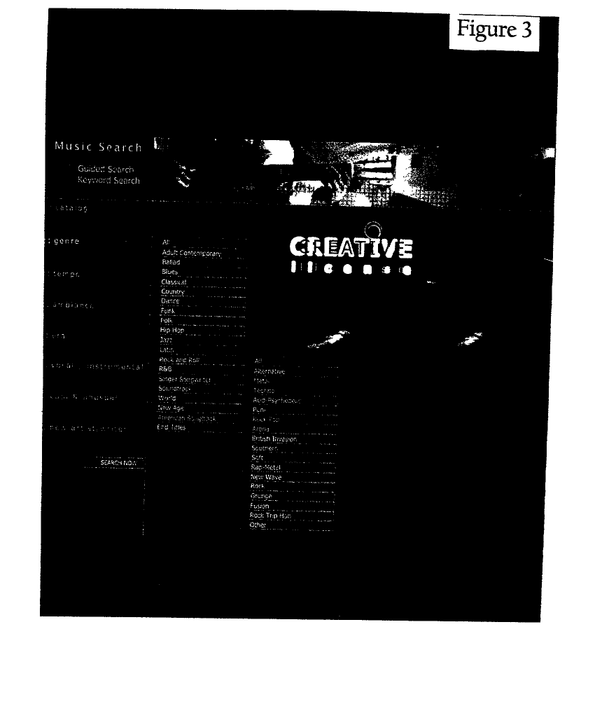

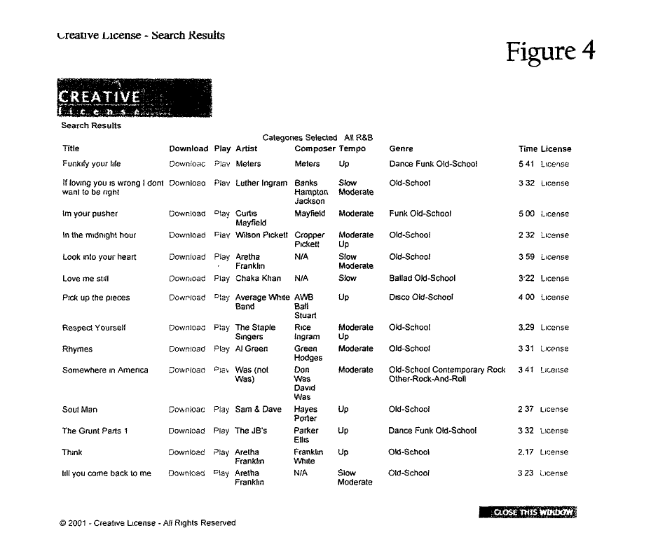

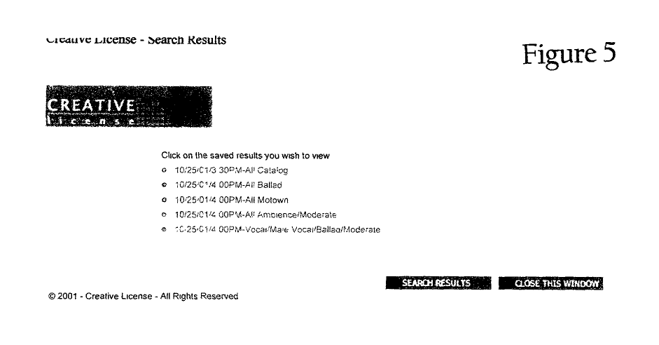

Creative License is a seamless Internet-based process which delivers digital music files to users who license music for Visual media FIG. 1. Music publishers, record companies and other owners of music transmit recordings by various artists through an Internet site with a search engine organized by criteria such as genre, era, tempo, and further aided by a Keyword search for song title, lyric. Composer and artist directly into personal computers, film editing and music production devices FIG. 2. By entering the site, users have broad and virtually instantaneous access to stream or download recordings that suit the creative requirements of the film or television production FIG. 3. The invention further functions as a creative tool by making available a vast library of recorded music and by introducing users to lesser known but imaginative choices of music FIG. 4. The site contains a database of alternate recordings of the same song title by different artists. FIG. 5 illustrates how the invention permits users to navigate the vast and expanding body of recorded music in an informed, organized manner by saving the search results

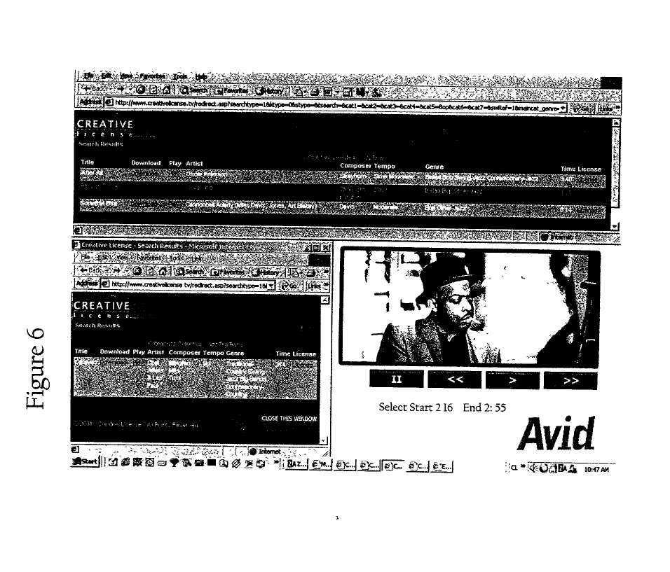

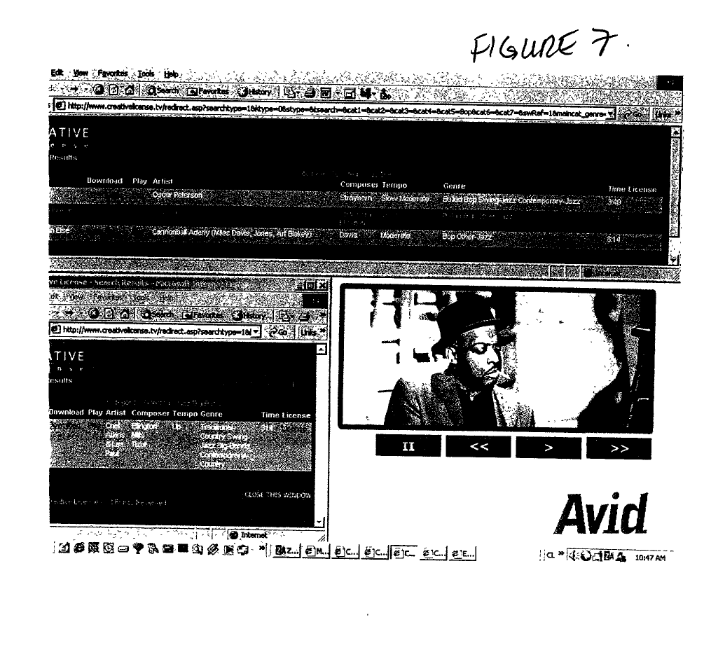

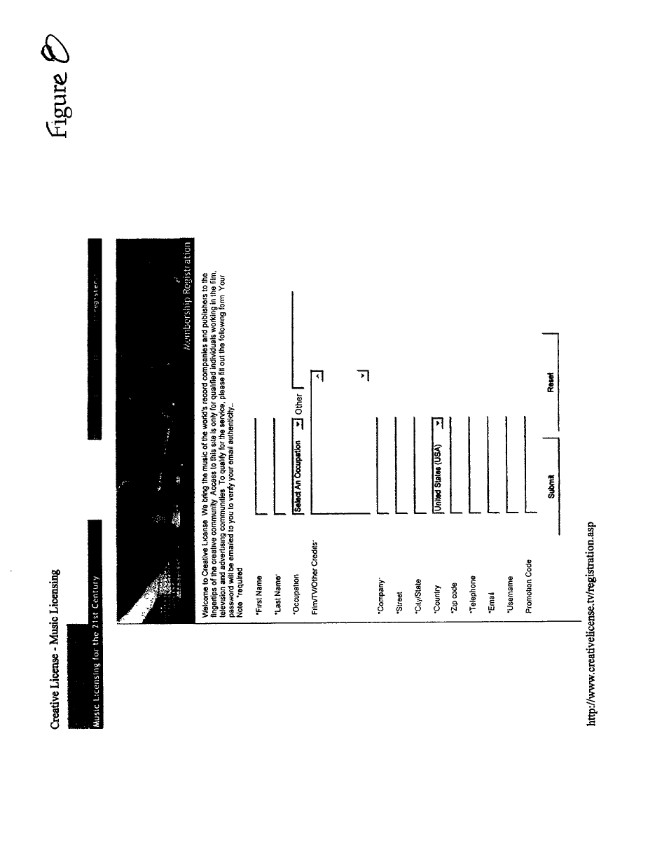

FIG. 6 illustrates how users may select a specific segment of a song for inclusion in a folder or insertion in a scene and then FIG. 7 to import a variety of music options directly into music and film production devices such as Avid and how saved search results can be played in any order as the visual scene repeats. FIG. 8 illustrates how after a musical selection is made a license may be requested directly from the copyright owner.

Creative license is designed to reduce the time between the initial film synchronization idea and the realization of that idea, including licensing, to virtual zero. Confronted with a visual image, music supervisors, directors, or film editors are able to instantaneously access a range of recordings, which express their idea. The site further assists users in refining and developing their concepts by providing an easy audio survey of options within a particular genre, era, style, or musical ambiance. The site is curated as experts in the various musical genres have developed the digital musical library. The site also reduces the physical distance between a project's creative contributors as the digital files can be shared and downloaded for review at any facility at another geographic location. FIG. 5 illustrates how by sharing the files, various parties can simultaneously evaluate a particular recording as it relates to the visual image.

The system is scaleable to thousands of music entries in various formats to make it easy for music producers and supervisors and ad agencies to download and import into various applications and video hardware. AIFF and WAV files are available for import to systems such as the Avid. Digital music files are available for use in applications like ProTools. By providing several formats, the music producer or supervisor will not be constrained by their choice of application or application hardware.

The users connect using the publicly available Internet through an ISP or Direct Network connection (T1, T3, etc.). A high speed connection is recommended for the size of the files (ASF, MP3-5 megabytes, AIFF and WAV files -60 megabytes).

FIG. 7 illustrates how the site allows users to download any existing type of digital music file for real time synchronization with visual images. The digital file can be directly delivered to the film/video editing bay for inclusion as temporary or permanent inclusion in the finished product. The site url is creativelicense.tv.

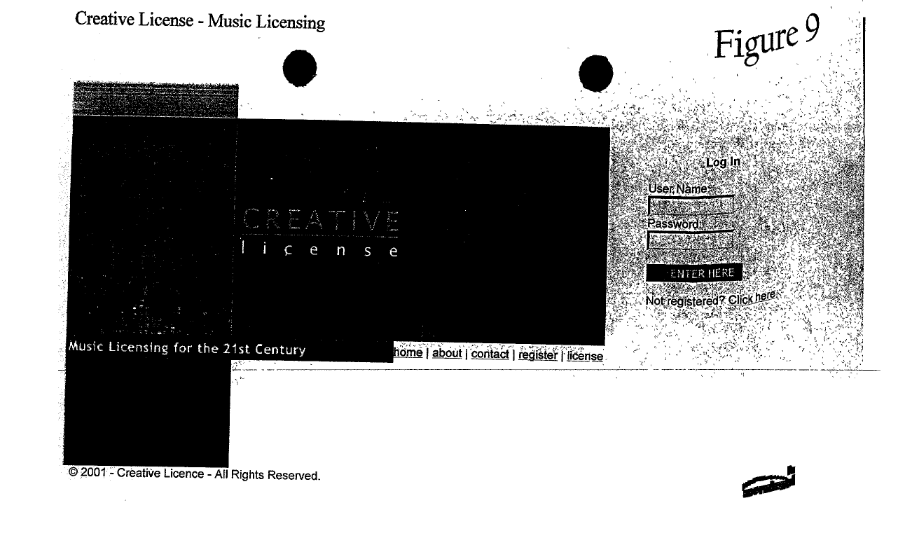

FIG. 9 illustrates that the system is an insular and available only to industry professionals (music supervisors, directors, film editors ad agencies).License holders also have a unique username and login to facilitate updates to profile and contact information. Users gain access to the site through an assigned pass code.

Licensing—FIG. 8 demonstrates how the site provides the user with information regarding ownership of publishing and master rights for licensing for commercial use and allows licensor and licensee to reach an agreed upon fee online.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A seamless online process to search for, synchronize with visual image, and license music in Visual media. comprising the steps of: installing music catalogs digitally in an audio database, organizing the database by objective and subjective criteria, through which users access, synchronize, and license the music.
